(19) United States
(12) Patent Application Publication
(10) Pub. No.: US 2026/0336932 A1
(43) Pub. Date: Oct. 29, 2026

(54) Automated Warehouse

(71) Applicant: Daifuku Co., Ltd., Osaka-shi (JP)

(72) Inventor: Mayu Ohira, Tokyo (JP)

(21) Appl. No.: 19/631,489

(22) Filed: Mar. 27, 2026

(30) Foreign Application Priority Data
Mar. 28, 2025 (JP) 2025-055768

(51) Int. Cl. B65G 1/06; F25D 13/04

(52) U.S. Cl. CPC B65G 1/065; F25D 13/04

(57) ABSTRACT

An automated warehouse includes warehouse layers on a plurality of floors, and a lifting transporter that transports articles between the warehouse layers on the respective floors. Each warehouse layer includes a plurality of transport aisles, a storage area that stores articles, a plurality of transport vehicles that each travel along the corresponding transport aisle to transport articles, and a connecting transporter that connects the transport aisles to transport articles. The storage area is disposed along each transport aisle. The connecting transporter transfers an article received from a transport vehicle on a first transport aisle to a transport vehicle on a second transport aisle. The lifting transporter transfers an article(W) received from the connecting transporter on a floor to the connecting transporter on another floor.

### CROSS-REFERENCE TO RELATED APPLICATION

This application claims priority to Japanese Patent Application No. 2025-055768 filed Mar. 28, 2025, the disclosure of which is hereby incorporated by reference in its entirety.

### BACKGROUND OF THE INVENTION

### Field of the Invention

The present invention relates to an automated warehouse including warehouse layers arranged on multiple floors and a lifting transporter that transports articles between the warehouse layers on different floors.

### Description of Related Art

An example of such an automated warehouse is described in Japanese Unexamined Patent Application Publication No. 2015-168573 (JP 2015-168573). In the background described hereafter, reference signs and names in parentheses are the reference signs and the names in JP 2015-168573.

The automated warehouse described in JP 2015-1685731 includes transport vehicles (transfer carts 60) that transport articles (W), multiple transport aisles (cart travel aisles 14) along which the transport vehicles (transfer carts 60) travel, and storage areas (storage shelves 10) in which the articles (W) are stored. The multiple transport aisles (cart travel aisles 14) are arranged in a lateral direction. The storage areas (storage shelves 10) are separately arranged on opposite sides of each transport aisle (cart travel aisle 14). A transport vehicle (transfer cart 60) transfers articles (W) to and from adjacent storage areas (storage shelves 10). The transport vehicle (transfer cart 60) onto which an article (W) is transferred from a storage area (storage shelf 10) travels on a transport aisle (cart travel aisle 14) to transport the article (W) to a predetermined position.

However, the transport vehicle (transfer cart 60) in the automated warehouse described in JP 2015-168573 cannot move the article (W) to a storage area (storage shelf 10) other than the adjacent storage areas (storage shelves 10) arranged on opposite sides of the transport aisle (cart travel aisle 14). When the storage position of each article (W) is not adjusted based on the type or the quantity of articles (W) already stored in each storage area (storage shelf 10), efficient loading and unloading of the articles (W) is difficult.

### SUMMARY OF THE INVENTION

Automated warehouses that can easily move articles to different storage areas are awaited.

In response to the above issue, the technique described below is provided.
An automated warehouse includes warehouse layers on a plurality of floors arranged in a vertical direction, and a lifting transporter that transports articles in the vertical direction between the warehouse layers on respective floors of the plurality of floors. Each of the warehouse layers on the plurality of floors includes a plurality of transport aisles, a plurality of transport vehicles that each travel along a corresponding transport aisle of the plurality of transport aisles to transport articles, a storage area that stores articles, and a connecting transporter that connects the plurality of transport aisles to transport articles. The plurality of transport aisles are arranged in a lateral direction perpendicular to an aisle direction in which at least one of the plurality of transport aisles extends. The storage area is disposed along each of the plurality of transport aisles. The connecting transporter extends in the lateral direction. The connecting transporter transfers an article received from a transport vehicle on a first transport aisle of the plurality of transport aisles to a transport vehicle on a second transport aisle of the plurality of transport aisles. The lifting transporter connects, in the vertical direction, the connecting transporter on a first warehouse layer of the warehouse layers on the plurality of floors to the connecting transporter on a second warehouse layer of the warehouse layers. The lifting transporter transfers an article received from the connecting transporter on a floor of the plurality of floors to the connecting transporter on another floor of the plurality of floors.

In this structure, the connecting transporter is used to transport articles between different transport aisles on a warehouse layer on a single floor, and the connecting transporter and the lifting transporter are used to transport articles between multiple warehouse layers on different floors. This allows the articles to be easily moved between storage areas in the automated warehouse with a simple structure.

Further features and advantages of the technique according to the present disclosure will be apparent from exemplary and nonlimiting embodiments described below with reference to the drawings.

### BRIEF DESCRIPTION OF THE DRAWINGS

FIG. 1 is a schematic plan view of an automated warehouse according to a first embodiment.

FIG. 2 is a cross-sectional view taken along line II-II in FIG. 1, showing an example operation in the automated warehouse.

FIG. 3 is a diagram describing an example operation in the automated warehouse shown in FIG. 1.

FIG. 4 is a schematic plan view of an example automated warehouse according to a second embodiment.

FIG. 5 is a schematic plan view of another example automated warehouse according to the second embodiment.

FIG. 6 is a schematic plan view of an automated warehouse according to a third embodiment.

### DESCRIPTION OF THE INVENTION

### First Embodiment

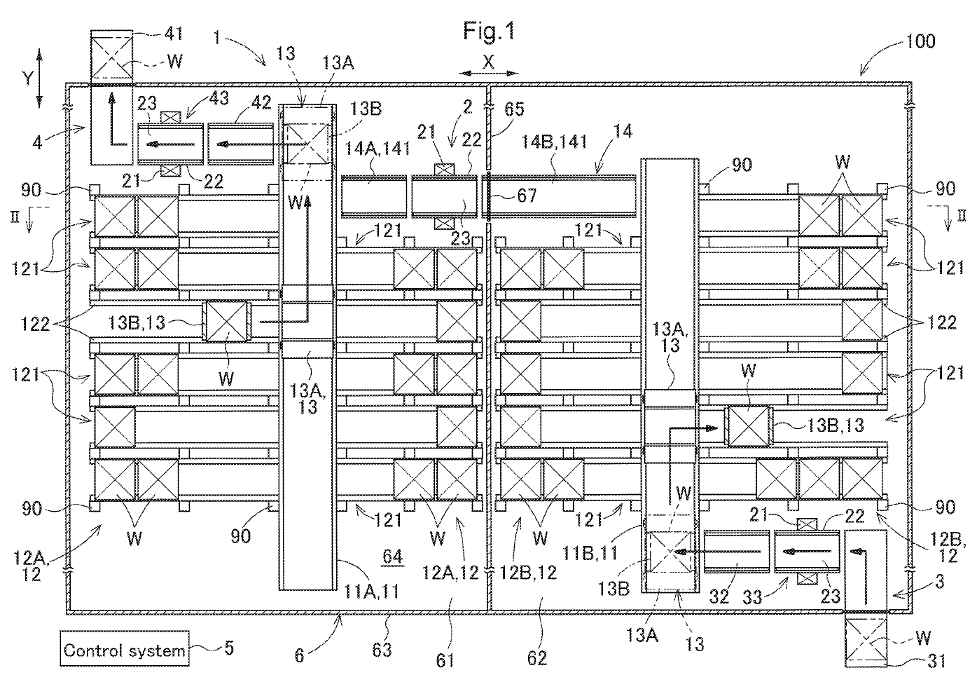

An automated warehouse 100 according to a first embodiment will now be described with reference to FIGS. 1-3.

As shown in FIG. 1, the automated warehouse 100 stores multiple articles W. As shown in the lower right part of FIG. 1, each article W transferred into the automated warehouse 100 is, before being stored, transported to a predetermined storage position inside the automated warehouse 100 without operator intervention. As shown in the upper left part of FIG. 1, each article W stored inside the automated warehouse 100 is transported to a predetermined unloading area outside the automated warehouse 100 without operator intervention. Hereafter, transferring the articles W into the predetermined storage position inside the automated warehouse 100 is referred to as loading, and transferring the articles W stored in the automated warehouse 100 out of the automated warehouse 100 is referred to as unloading. The boundary between the inside and the outside of the automated warehouse 100 is defined by, for example, walls or fences surrounding warehouse layers 1 (described later). Without the walls or fences, the boundary between the inside and the outside of the automated warehouse 100 is defined by the boundary defining the area into which the operator is not allowed to enter during loading and unloading operations. Although the articles W may be of any type or appearance, the articles W in the present embodiment are loaded pallets. The figures show the articles W without distinguishing between the loaded articles and the pallets.

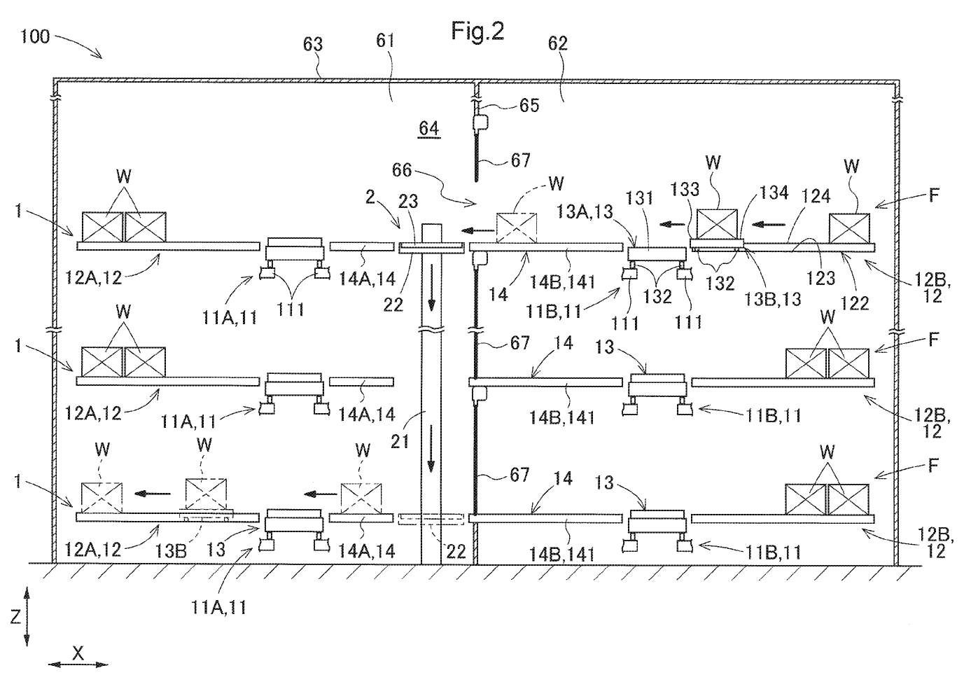

As shown in FIG. 2, the automated warehouse 100 includes multiple floors F arranged in a vertical direction Z, multiple warehouse layers 1 that store the articles W, and a lifting transporter 2 that transports the articles W between the multiple warehouse layers 1.

As shown in FIG. 1, the automated warehouse 100 according to the present embodiment further includes a loading system 3 for loading the articles W, an unloading system 4 for unloading the articles W, and a control system 5. The loading system 3 causes the articles W to be transferred onto at least one warehouse layer 1. The unloading system 4 causes the articles W to be transferred out of at least one warehouse layer 1. The control system 5 controls and causes the loading system 3, the unloading system 4, various components on the multiple warehouse layers 1, and the lifting transporter 2 to perform the loading and unloading operations.

As shown in FIG. 2, the floors F are arranged along surfaces perpendicular to the vertical direction Z. Examples of the floors F include imaginary planes defined at positions spaced at specific intervals in the vertical direction Z and floor surfaces of a building having multiple floors. The automated warehouse 100 according to the present embodiment has a structure integrating multiple columns 90 shown in FIG. 1 and other structural members (not shown). The floors F extend along imaginary planes defined at positions spaced at specific intervals in the vertical direction Z.

Each warehouse layer 1 is disposed on a different floor F. In the present embodiment, each warehouse layer 1 has its structural members fixed to the multiple columns 90 that are fixed to the floor surface or the foundation and extending in the vertical direction Z. More specifically, the columns 90 receive the structural members serving as the warehouse layers 1 fixed at positions corresponding to each floor F.

As shown in FIGS. 1 and 2, each warehouse layer 1 includes multiple transport aisles 11, storage areas 12 in which the articles W are stored, multiple transport vehicles 13 that transport the articles W, and a connecting transporter 14 that connects the multiple transport aisles 11. Each transport vehicle 13 travels along the corresponding transport aisle 11. The transport vehicle 13 transfers the article W stored in the storage area 12 to a lifting transporter 2 (described later) to have the article W transported to the warehouse layer 1 on another floor F and unloaded as appropriate. An article W to be loaded is transported by the lifting transporter 2 to the warehouse layer 1 on a specific floor F and transported by the transport vehicle 13 to a storage area 12.

The positional relationship between the components on each warehouse layer 1 can be easily understood based on the positions of the transport aisles 11. Hereafter, the direction in which at least one of the transport aisles 11 extends is referred to as an aisle direction Y, and the direction perpendicular to the aisle direction Y is referred to as a lateral direction X.

The multiple transport aisles 11 are arranged in the lateral direction X. In the example shown in FIG. 1, two transport aisles 11 spaced from each other are arranged in the lateral direction X. In the present embodiment, each transport aisle 11 includes a pair of transport rails 111 extending in the aisle direction Y. The transport rails 111 have a surface on which travel wheels 132 (refer to FIG. 2) in the transport vehicles 13 rotate. For ease of explanation, the two transport aisles 11 illustrated in FIGS. 1 and 2 may be referred to as a first transport aisle 11A and a second transport aisle 11B. In FIG. 1, the first transport aisle 11A is on the left and the second transport aisle 11B is on the right.

The storage areas 12 are arranged along each of the multiple transport aisles 11. In the present embodiment, the storage areas 12 are adjacent to the transport aisles 11 in the lateral direction X. In the present embodiment, the storage areas 12 are arranged on opposite sides of each transport aisle 11 in the lateral direction X. In the example shown in FIG. 1, the storage areas 12 are arranged on opposite sides of the first transport aisle 11A and opposite sides of the second transport aisle 11B in the lateral direction X. The storage areas 12 arranged on opposite sides of the first transport aisle 11A in the lateral direction X may be hereafter referred to as first storage areas 12A. The storage areas 12 arranged on opposite sides of the second transport aisle 11B in the lateral direction X may be hereafter referred to as second storage areas 12B.

In the present embodiment, each storage area 12 includes multiple storage racks 121 arranged in the aisle direction Y. Each storage rack 121 includes a pair of mount rails 122 on which the articles W can be arranged in the lateral direction X for storage. Each of the pair of mount rails 122 extends in the lateral direction X in the storage area 12. More specifically, each of the pair of mount rails 122 has a support surface 124 that supports the articles W, and a travel surface 123 on which travel wheels 132 in a second cart 13B (described later) rotate. The distance between the support surfaces 124 of the pair of mount rails 122 is less than the width, in the aisle direction Y, of a target article W to be stored on the storage rack 121 in the orientation for storage. Thus, the bottom surface of the article W extends across the support surfaces 124 of the pair of mount rails 122. The travel surfaces 123 of the pair of mount rails 122 are arranged based on the wheels in the second cart 13B (described later).

In the present embodiment, the transport vehicles 13 include first carts 13A that travel along the respective transport aisles 11 and second carts 13B that travel in the respective storage areas 12.

As shown in FIG. 2, each first cart 13A includes a transporter 131 onto which a second cart 13B is mountable and at least a pair of travel wheels 132 arranged on opposite sides of the transporter 131 in the lateral direction X. The transporter 131 has an upper surface onto which the second cart 13B is mountable. The pair of travel wheels 132 are arranged on opposite sides of the transporter 131 in the lateral direction X with a distance between the pair of travel wheels 132 that is substantially the same as the distance between the pair of transport rails 111 in the lateral direction X. The pair of travel wheels 132 are supported by the transporter 131 in a rotatable manner. Each first cart 13A driven by a drive (not shown), such as an electric motor, rotates some or all the travel wheels 132 to move in the aisle direction Y along the pair of transport rails 111. Although not described in detail, the position of each first cart 13A in the aisle direction Y is indicated in detection information obtained by a detector (not shown) (e.g., an encoder that detects the rotation of the travel wheels 132 or a range sensor that detects the distance to a target object). The control system 5 controls the first carts 13A based on the detection information received from the detector.

A first cart 13A on which the second cart 13B is mounted travels along the corresponding transport aisle 11. In other words, the transport vehicle 13 in the present embodiment is a parent-child cart including the first cart 13A as a parent cart and the second cart 13B as a child cart. The first cart 13A allows the second cart 13B to separate in the lateral direction X. More specifically, the transporter 131 includes no component that restricts the second cart 13B from moving in the lateral direction X. Thus, a second cart 13B transported by the first cart 13A to a position adjacent to a storage rack 121 in the lateral direction X can move onto the mount rails 122. A second cart 13B traveling on the mount rails 122 can also move onto a first cart 13A disposed at a position adjacent to the mount rails 122 in the lateral direction X.

Each second cart 13B includes a mount 133 onto which an article W is mountable and at least the pair of travel wheels 132 arranged on opposite sides of the mount 133 in the lateral direction X. The mount 133 has a mount surface 134 onto which the article W is placeable. The mount surface 134 has a width in the aisle direction Y that is less than the width of the article W in the aisle direction Y in the orientation for storage in the storage rack 121. The pair of travel wheels 132 are arranged on opposite sides of the mount 133 in the lateral direction X with a distance between the travel wheels 132 that is substantially the same as the distance between the pair of mount rails 122 in the aisle direction Y. The pair of travel wheels 132 are supported by the mount 133 in a rotatable manner. More specifically, the distance between the travel wheels 132 arranged on opposite sides of the mount 133 in the aisle direction Y is the same as the distance between the travel surfaces 123 of the pair of mount rails 122 in the aisle direction Y. In the present embodiment, the travel surfaces 123 are arranged at positions lower than the support surfaces 124 and are arranged between the pair of support surfaces 124 in the aisle direction Y. The mount 133 is thus supported by the travel surfaces 123 of the pair of mount rails 122 in each storage rack 121 through the travel wheels 132.

The second cart 13B rotates the travel wheels 132 to move between the transporter 131 of the first cart 13A and the storage rack 121, or move on the storage rack 121 in the lateral direction X. Similarly to the first cart 13A, each second cart 13B driven by a drive (not shown), such as an electric motor, rotates some or all the travel wheels 132 to travel. Although not described in detail, the position of each second cart 13B in the lateral direction X is indicated in detection information obtained by a detector (not shown) (e.g., an encoder that detects the rotation of the travel wheels 132 or a range sensor that detects the distance to a target object), similarly to the first cart 13A. The control system 5 controls the second carts 13B based on the detection information received from the detector.

In the present embodiment, each second cart 13B includes an elevator (not shown) that raises and lowers its mount surface 134 to place an article W onto the support surface 124 or lift an article W placed on the support surface 124. The elevator raises and lowers the mount surface 134 relative to the mount 133. The elevator raises and lowers the mount surface 134 with a driving force from a drive such as an electric motor. The second cart 13B raises and lowers the mount surface 134 on which an article W is placed to transfer the article W onto and from the storage rack 121.

The second cart 13B moves on the storage rack 121 while raising the mount surface 134 to a position that causes no contact between the bottom surface of the article W and the support surfaces 124 to transfer the article W onto the storage rack 121. The second cart 13B that has moved to the storage position of the article W on the storage rack 121 lowers the mount surface 134 to a position lower than a position that causes contact between the bottom surface of the article W and the support surfaces 124 and then places the article W onto the support surfaces 124. The second cart 13B then exits the storage rack 121 with the mount surface 134 lowered to a position lower than the support surfaces 124. In other words, the second cart 13B moves toward the corresponding transport aisle 11.

The second cart 13B moves to a position below a target article W to be transferred from the storage rack 121 while lowering the mount surface 134 to a position lower than the bottom surface of the target article W that is placed on the support surfaces 124. The second cart 13B that has reached the position below the article W raises the mount surface 134 to lift the article W off the support surfaces 124. The second cart 13B then exits the storage rack 121 with the mount surface 134 raised to a position that causes no contact between the bottom surface of the article W and the support surfaces 124.

The connecting transporters 14 transport the articles W. Each connecting transporter 14 connects two different transport aisles 11 on the same warehouse layer 1 to allow the articles W to be transferred between the transport vehicles 13 in the two transport aisles 11. More specifically, the connecting transporter 14 can transfer the article W received from a transport vehicle 13 in a first transport aisle 11 to a transport vehicle 13 in a second transport aisle 11. In the example shown in FIG. 1, the connecting transporter 14 connects the first transport aisle 11A and the second transport aisle 11B. More specifically, the connecting transporter 14 illustrated in FIG. 1 transfers articles W between the transport vehicle 13 traveling in the first transport aisle 11A and the transport vehicle 13 traveling in the second transport aisle 11B.

In the present embodiment, an article W is transferred from a transport vehicle 13 to the connecting transporter 14 by a transferrer included in the transport vehicle 13. The mount surface 134 of the second cart 13B functions as the transferrer. More specifically, the mount surface 134 is the surface of a conveyor that moves the article W in the lateral direction X. After being moved by the first cart 13A to a position adjacent to the connecting transporter 14 in the lateral direction X, the second cart 13B moves the mount surface 134 to transfer the article W from the mount surface 134 to the connecting transporter 14.

The connecting transporter 14 extends in the lateral direction X. In the present embodiment, the connecting transporter 14 extends straight in the lateral direction X from a position along the first transport aisle 11A in the aisle direction Y when viewed in the vertical direction Z. This structure minimizes the area occupied by the connecting transporter 14 when viewed in the vertical direction Z, facilitating efficient storage of the articles W in the storage areas 12 within a limited area.

In the present embodiment, each connecting transporter 14 includes lateral conveyors 141 that can hold and transport multiple articles W in the lateral direction X. Examples of the lateral conveyors 141 include roller conveyors, belt conveyors, and other fixed conveyors. This simplifies the structure of the connecting transporter 14.

In the example shown in FIG. 1, the connecting transporter 14 includes a pair of lateral conveyors 141 and a lift transferrer 23 included in the lifting transporter 2. As described in detail later, the lift transferrer 23 moves the articles W in the lateral direction X. The pair of lateral conveyors 141 are arranged on opposite sides of the lift transferrer 23 in the lateral direction X. In this arrangement, an article W transferred to a first lateral conveyor of the pair of lateral conveyors 141 is further transferred to a second lateral conveyor of the pair of lateral conveyors 141 through the lift transferrer 23. For ease of explanation, a lateral conveyor 141 of the pair of lateral conveyors 141 adjacent to the first transport aisle 11A in the lateral direction X may be referred to as a first lateral conveyor 14A. A lateral conveyor 141 of the pair of lateral conveyors 141 adjacent to the second transport aisle 11B in the lateral direction X may be referred to as a second lateral conveyor 14B.

As shown in FIG. 2, the lifting transporter 2 connects the connecting transporters 14 on the warehouse layers 1 on different floors F in the vertical direction Z. More specifically, the lifting transporter 2 can transfer an article W received from a connecting transporter 14 on a floor F to a connecting transporter 14 on another floor F. As described above, the lifting transporter 2 is disposed between the first lateral conveyor 14A and the second lateral conveyor 14B in the present embodiment. This structure allows the article W transported to the lifting transporter 2 to be moved to one of the first storage area 12A and the second storage area 12B that is more appropriate. For example, the lifting transporter 2 can transfer the article W to the first lateral conveyor 14A to store the article W in the first storage area 12A. The lifting transporter 2 can also transfer the article W to the second lateral conveyor 14B to store the article W in the second storage area 12B. Thus, the storage areas of the articles W can be determined based on occupancy levels of the first storage area 12A and the second storage area 12B. This facilitates efficient loading and unloading of the articles W.

The lifting transporter 2 includes posts 21 extending in the vertical direction Z, a lift mount 22 that ascends and descends in the vertical direction Z along the posts 21, and the lift transferrer 23 that ascends and descends together with the lift mount 22.

The lift mount 22 stops at any position in the vertical direction Z at which the article W can be transferred to the connecting transporter 14 on a warehouse layer 1 on the corresponding floor F. The lift transferrer 23 moves the articles W placed on the lift transferrer 23 in the lateral direction X. Examples of the lift transferrer 23 include a conveyor and other transferrers installed on the upper surface of the lift mount 22. In the present embodiment, at least one floor F has a loading-unloading space (not shown) for loading or unloading the articles W. The lift transferrer 23 receives an article W from the loading-unloading space or transfers an article W to the loading-unloading space in the present embodiment. In other words, the lifting transporter 2 in the present embodiment can also perform the loading and unloading operations. This structure easily reduces the overall area occupied by the automated warehouse 100.

The loading system 3 includes a receiver device 31 that connects the inside and the outside of the automated warehouse 100, loaders 32 that transfer each article W transferred to the automated warehouse 100 onto one of the warehouse layers 1, and a loading lifter 33 that transports the articles W to the loaders 32. In the example shown in FIG. 1, the loading system 3 causes a target article W for loading to be transferred to the transport vehicle 13 traveling in the second transport aisle 11B.

The receiver device 31 transfers the articles W from the outside of the automated warehouse 100 to the inside of the automated warehouse 100. In other words, the receiver device 31 moves the articles W from outside the automated warehouse 100 to inside. The receiver device 31 is, for example, a conveyor or another transferrer that is disposed on the lowest floor F of the multiple floors F and moves the articles W to the loading lifter 33.

An article W to be stored on one of the warehouse layers 1 on the floors F is transferred to a loader 32, which configured to receive articles W. The loader 32 transfers the article W onto at least one warehouse layer 1 on the multiple floors F. In the present embodiment, the loader 32 is disposed on the warehouse layer 1 on each floor F to transfer the articles W to the transport vehicles 13 traveling in the transport aisles 11. More specifically, each loader 32 is disposed adjacent to the transport aisle 11 in the lateral direction X to move the articles W in the lateral direction X. In the example shown in FIG. 1, the loader 32 is disposed adjacent to the second transport aisle 11B in the lateral direction X. Examples of the loader 32 include a conveyor and other transferrers that can move the articles W.

The loading lifter 33 transports articles W in the vertical direction Z to the warehouse layers 1 and the loaders 32 on the multiple floors F. In the present embodiment, the loading lifter 33 is disposed between the receiver device 31 and the loaders 32 when viewed in the vertical direction Z. An article W transferred by the receiver device 31 is transported to a loader 32 on the same floor F or a loader 32 on another floor F through the loading lifter 33.

Similarly to the lifting transporter 2, the loading lifter 33 illustrated in FIG. 1 includes posts 21 extending in the vertical direction Z, a lift mount 22 that ascends and descends in the vertical direction Z along the posts 21, and a lift transferrer 23 that ascends and descends together with the lift mount 22. The lift mount 22 in the loading lifter 33 stops at any position in the vertical direction Z at which the article W can be transferred from the receiver device 31 and at which the article W can be transferred to the loader 32 on the corresponding floor F. The lift transferrer 23 in the loading lifter 33 receives the article W from the receiver device 31 and transfers the article W to the corresponding loader 32.

The unloading system 4 includes a shipping device 41 that connects the inside and the outside of the automated warehouse 100, unloaders 42 that transfer articles W out of the warehouse layers 1, and an unloading lifter 43 that transports the articles W to the shipping device 41. In the example shown in FIG. 1, the unloading system 4 causes the target article W for unloading to be received from the transport vehicle 13 traveling in the first transport aisle 11A and transferred out of the automated warehouse 100.

The shipping device 41 transfers the articles W out of the automated warehouse 100. In other words, the shipping device 41 moves the articles W from inside the automated warehouse 100 to outside. The shipping device 41 is, for example, a conveyor or another transferrer that is disposed on the lowest floor F of the multiple floors F and moves the articles W out of the automated warehouse 100.

An article W stored on one of the warehouse layers 1 on the floors F is transferred out to the corresponding unloader 42, which is configured to convey articles W from a warehouse layer 1. The unloader 42 transfers the article W out of at least one warehouse layer 1 on the multiple floors F. In the present embodiment, the unloader 42 is disposed on the warehouse layer 1 on each floor F to receive the articles W from the transport vehicles 13 traveling in the transport aisles 11. More specifically, each unloader 42 is disposed adjacent to the transport aisle 11 in the lateral direction X to move the articles W in the lateral direction X. In the example shown in FIG. 1, the unloader 42 is disposed adjacent to the first transport aisle 11A in the lateral direction X. Similarly to the loader 32, examples of the unloader 42 include a conveyor and other transferrers that can move the articles W.

The unloading lifter 43 transports articles W in the vertical direction Z to the warehouse layers 1 and the unloaders 42 on the multiple floors F. In the present embodiment, the unloading lifter 43 is disposed between the shipping device 41 and the unloaders 42 when viewed in the vertical direction Z. An article W transferred by the unloader 42 from the corresponding warehouse layer 1 is transported to the shipping device 41 through the unloading lifter 43.

Similarly to the lifting transporter 2, the unloading lifter 43 illustrated in FIG. 1 includes posts 21 extending in the vertical direction Z, a lift mount 22 that ascends and descends in the vertical direction Z along the posts 21, and a lift transferrer 23 that ascends and descends together with the lift mount 22. The lift mount 22 in the unloading lifter 43 stops at any position in the vertical direction Z at which the article W can be transferred to the unloader 42 on the corresponding floor F and at which the article W can be transferred to the shipping device 41. The lift transferrer 23 in the unloading lifter 43 receives the article W from the unloader 42 and transfers the article W to the shipping device 41.

The lifting transporter 2 may transport the articles W through a path different from paths for the loading lifter 33 and the unloading lifter 43. In the example shown in FIG. 1, the lifting transporter 2 transfers the articles W to and from the loading-unloading space outside the automated warehouse 100. The loading system 3 causes the articles W to be loaded from the receiver device 31 different from the loading-unloading space. The unloading system 4 causes the articles W to be unloaded to the shipping device 41 different from the loading-unloading space. This structure allows multiple areas to be candidate areas for loading or unloading the articles W, thus facilitating efficient loading and unloading of the articles W.

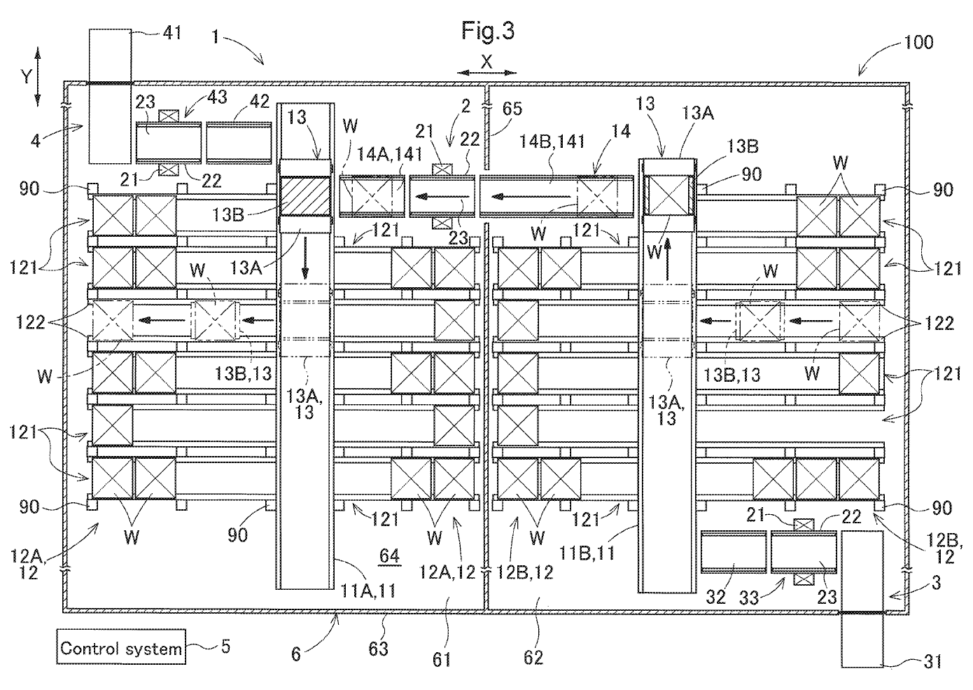

In the present embodiment, the control system 5 controls at least the multiple transport vehicles 13 and the connecting transporters 14 and causes the articles W to be transferred between the transport vehicles 13 traveling in different transport aisles 11 as shown in FIG. 3. More specifically, the control system 5 causes the transport vehicles 13 to move to receive and transfer the articles W and causes the connecting transporters 14 to move the articles W.

The control system 5 includes a computation processor such as a microcomputer and a peripheral circuit such as a memory. The functions of the control system 5 are implemented by hardware such as the computation processor and a program executed on the hardware cooperating with each other. The control system 5 may be implemented by a single device or by multiple devices that can communicate with one another. For example, the control system 5 includes hardware mounted on each transport vehicle 13 and each connecting transporter 14, and hardware that can communicate with such hardware.

In the example shown in FIG. 3, the control system 5 controls the multiple transport vehicles 13 and the connecting transporter 14 and causes the article W stored in the second storage area 12B to be moved to the first storage area 12A. The article W stored in the second storage area 12B is moved to the first storage area 12A through a first process, a second process, and a third process.

In the first process, the target article W to be moved is transferred out of the second storage area 12B. In the first process, the control system 5 controls the transport vehicle 13 traveling in the second transport aisle 11B to cause the article W stored in the second storage area 12B to be transferred out of the second storage area 12B. This causes the first cart 13A on which the second cart 13B is mounted and traveling in the second transport aisle 11B to move to a position adjacent to the storage rack 121 storing a target article W for transfer in the lateral direction X. The second cart 13B then enters the storage rack 121 to transfer the target article W out of the storage rack 121.

In the second process, the target article W to be moved is transferred to the transport vehicle 13 traveling in the first transport aisle 11A. In the second process, the control system 5 controls the transport vehicle 13 traveling in the second transport aisle 11B and the connecting transporter 14 and causes the target article W to be transferred to another transport vehicle 13 traveling in the first transport aisle 11A. This causes the first cart 13A on which the second cart 13B holding the target article W is mounted and traveling in the second transport aisle 11B to move to a position adjacent to the second lateral conveyor 14B in the lateral direction X. At the position adjacent to the second lateral conveyor 14B in the lateral direction X, the second cart 13B transfers the article W to the second lateral conveyor 14B. The second lateral conveyor 14B then moves the transferred article W to the first lateral conveyor 14A through the lifting transporter 2. The first lateral conveyor 14A then transfers the target article W to the transport vehicle 13 traveling in the first transport aisle 11A. More specifically, the first lateral conveyor 14A transfers the target article W to the second cart 13B mounted on the first cart 13A that is waiting at the position adjacent to the first lateral conveyor 14A in the lateral direction X.

In the third process, the target article W to be moved is stored in the first storage area 12A. In the third process, the control system 5 controls the transport vehicle 13 traveling in the first transport aisle 11A and causes the target article W to be stored into the first storage area 12A. This causes the first cart 13A on which the second cart 13B holding the target article W is mounted to move to a position adjacent to the storage rack 121 to which the target article W is to be transferred in the lateral direction X. The second cart 13B then moves from the position adjacent to the storage rack 121 in the lateral direction X onto the storage rack 121 to place the target article W on the pair of mount rails 122 at the storage position of the article W on the storage rack 121.

In the present embodiment, the warehouse layers 1 on the multiple floors F further include an environment system 6 that maintains the environmental conditions of the storage areas 12. The environmental conditions are determined based on environmental factors that may affect the articles W, such as temperature, humidity, gas composition, and cleanliness. The environment system 6 manages, for example, the temperatures in the storage areas 12. More specifically, the environment system 6 causes the storage areas 12 to be in multiple sections set under different temperature conditions. This structure allows temperature treatment of the articles W in the automated warehouse 100. The temperature treatment is performed to change or maintain the properties of the target article W to be moved based on a predetermined temperature change for the article W. For example, when the articles W are fermented food, the automated warehouse 100 including the environment system 6 can maintain a storage area 12 at room temperature to ferment the articles W. The fermented articles W are then stored in a storage area 12 maintained at a cool temperature to reduce the fermentation rate for storage for a predetermined period.

The environment system 6 includes a first temperature section 61, a second temperature section 62, a partition wall 65 separating the first temperature section 61 from the second temperature section 62, openings 66 in the partition wall 65, and doors 67 that open and close the respective openings 66.

The first temperature section 61 is in a first temperature range. The first temperature section 61 includes part of each warehouse layer 1. More specifically, the first temperature section 61 includes at least the transport aisles 11 and the storage areas 12. In the example shown in FIG. 1, the first temperature section 61 includes the first transport aisle 11A, the first storage areas 12A, the transport vehicle 13, part of the connecting transporter 14, and the lifting transporter 2. The first temperature section 61 includes the first lateral conveyor 14A in the connecting transporter 14. As shown in FIG. 2, the first temperature section 61 includes all the warehouse layers 1 arranged on the multiple floors F in the present embodiment. The first temperature section 61 is surrounded by surrounding walls 63 that have a structure and are formed from a material appropriate for maintaining the first temperature section 61 in the first temperature range. The surrounding walls 63 shown in FIGS. 1 and 2 surround the warehouse layers 1 in the lateral direction X and the aisle direction Y, as well as from above.

The second temperature section 62 is in a second temperature range. The second temperature section 62 includes part of each warehouse layer 1 and a space adjacent to the first temperature section 61. More specifically, the second temperature section 62 includes, similarly to the first temperature section 61, at least the transport aisles 11 and the storage areas 12. In the example shown in FIG. 1, the second temperature section 62 includes the second transport aisle 11B, the second storage areas 12B, the transport vehicle 13, and part of the connecting transporter 14. The second temperature section 62 includes the second lateral conveyor 14B in the connecting transporter 14. In the present embodiment, the second temperature section 62 is surrounded by the surrounding walls 63 that have a structure and are formed from a material appropriate for maintaining the second temperature section 62 in the second temperature range. In the example shown in FIGS. 1 and 2, the surrounding walls 63 surrounding the first temperature section 61 and the second temperature section 62 are integral. This structure easily simplifies the overall structure of the automated warehouse 100.

The second temperature range differs from the first temperature range. The first temperature range is closer to room temperature than the second temperature range is. In this case, the second temperature section 62 includes, for example, an air conditioner to lower the temperature in the second temperature section 62. This structure allows temperature control of the articles W within the automated warehouse 100 based on the conditions.

The partition wall 65 has a predetermined degree of insulation performance. Each opening 66 extends through the partition wall 65 in the lateral direction X to allow passage of the articles W. The structure, a material, and a device for each door 67 may be combined as appropriate to reduce heat transfer between the first temperature section 61 and the second temperature section 62 when the corresponding opening 66 is closed. Examples of the door 67 include a door or an air curtain formed from a heat-insulating material as shown in FIGS. 1 and 2.

The door 67 is open when the article W is moved between the first temperature section 61 and the second temperature section 62. The opening 66 is closed when the opening 66 is not to be open. In the example shown in FIG. 2, the article W is transferred between the first temperature section 61 and the second temperature section 62 on the highest floor F. More specifically, the article W is transferred from the second lateral conveyor 14B to the lifting transporter 2 with the door 67 on the uppermost floor F being open. On floors F other than the highest floor F, no article W is transferred between the first temperature section 61 and the second temperature section 62, and thus the doors 67 on these floors F are closed.

The lifting transporter 2 may be disposed in the first temperature section 61. In this structure, the lifting transporter 2 is disposed in a space maintained at or close to room temperature. The lifting transporter 2 disposed in a space maintained at or close to room temperature has a lower level of expected performance than the lifting transporter 2 disposed in a space maintained at a temperature higher or lower than room temperature. For example, the lifting transporter 2 disposed in a space maintained at a low temperature is to have a structure or include a device to allow the lifting transporter 2 to operate normally at low temperatures.

### Second Embodiment

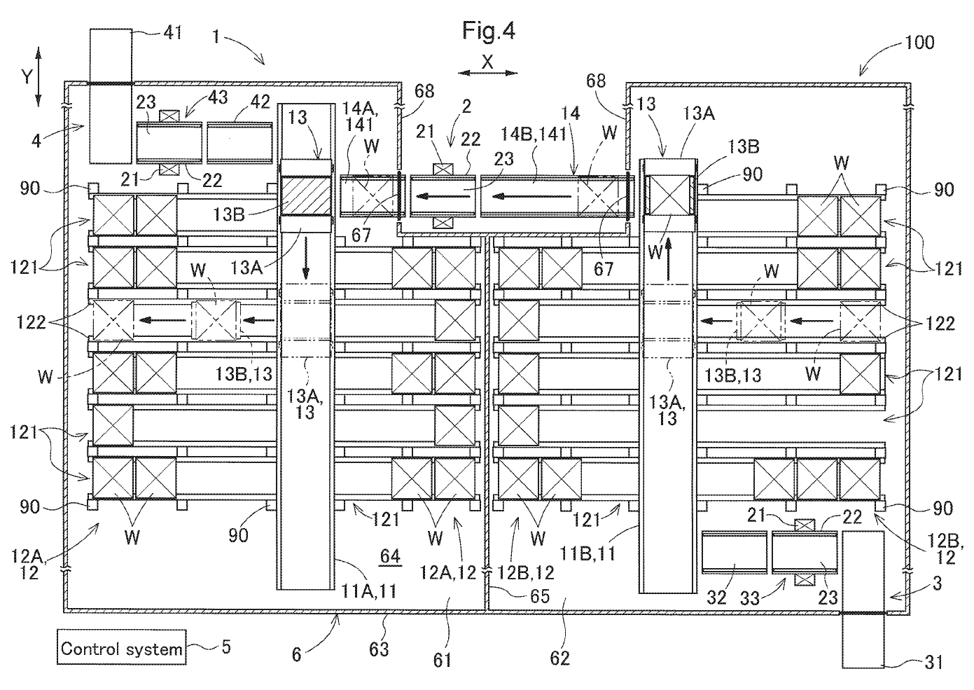

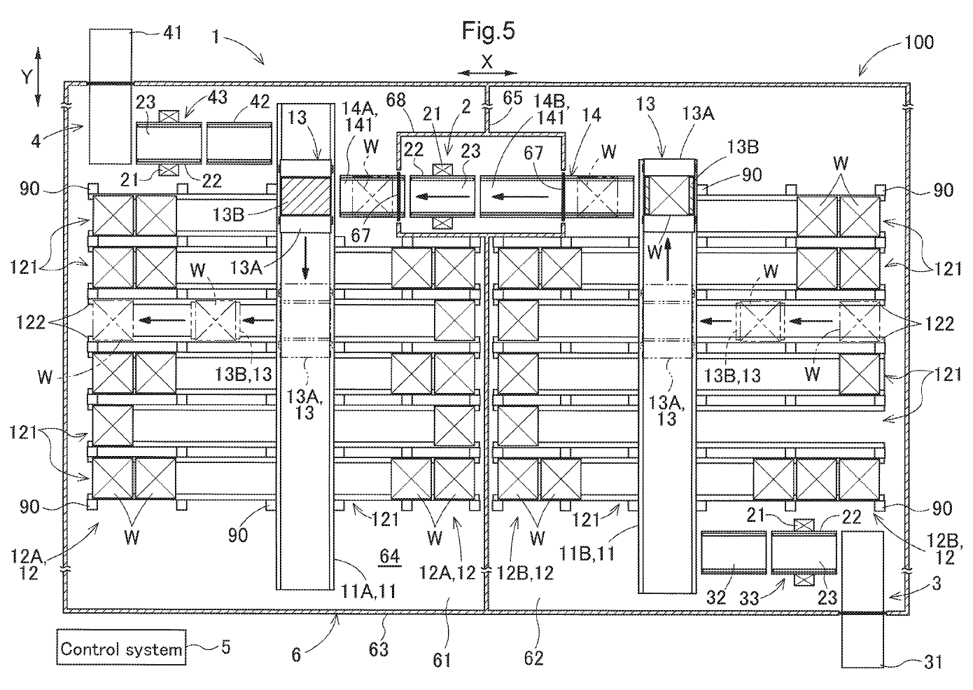

An automated warehouse 100 according to a second embodiment will now be described with reference to FIGS. 4 and 5. The automated warehouse 100 according to the second embodiment differs from the automated warehouse 100 according to the first embodiment in the structure of the warehouse layers 1. The automated warehouse 100 according to the second embodiment will be described focusing on its differences from the automated warehouse 100 according to the first embodiment. The common structures between the automated warehouse 100 according to the second embodiment and the automated warehouse 100 according to the first embodiment will not be described. FIG. 4 is a schematic plan view of an example automated warehouse 100 according to the second embodiment. FIG. 5 is a schematic plan view of another example automated warehouse 100 according to the second embodiment. The automated warehouse 100 illustrated in FIG. 4 will be described first, and the automated warehouse 100 illustrated in FIG. 5 will be described subsequently.

In the present embodiment, as shown in FIG. 4, the warehouse layers 1 on the multiple floors F include a storage room 64 surrounded by surrounding walls 63. The storage room 64 includes the storage areas 12. The storage room 64 includes the transport aisles 11 and part of the connecting transporter 14, in addition to the storage areas 12. In the example shown in FIG. 4, the surrounding walls 63 surround the first storage area 12A, the second storage area 12B, the first transport aisle 11A, the second transport aisle 11B, the multiple transport vehicles 13, part of the first lateral conveyor 14A, and part of the second lateral conveyor 14B. The surrounding walls 63 shown in FIG. 4 surround all the warehouse layers 1 together on opposite sides in the lateral direction X and opposite sides in the aisle direction Y. A surrounding wall 63 not shown in FIG. 4 is disposed above the warehouse layer 1.

The storage room 64 is maintained to satisfy the preset environmental conditions. The surrounding walls 63 have a structure and are formed from a material appropriate for maintaining the storage room 64 under the environmental conditions. The storage room 64 includes equipment inside to maintain the environmental conditions. As described in the first embodiment, the surrounding walls 63 are formed from, for example, a heat-insulating material for the environmental condition of maintaining the temperature within a specified range. The storage room 64 includes air conditioning equipment such as an air conditioner. The surrounding walls 63 have a structure and are formed from, for example, a material to prevent dust from entering the storage room 64 for the environmental condition of maintaining the cleanliness within a specified range. The storage room 64 includes a dust collector or another air purifier that collects dust.

The storage room 64 illustrated in FIG. 4 further includes a partition wall 65 that separates the first storage area 12A from the second storage area 12B. This structure allows the first storage area 12A and the second storage area 12B to be under different environmental conditions.

The lifting transporter 2 is disposed outside the storage room 64. In the present embodiment, the surrounding walls 63 include boundary walls 68 for disposing the lifting transporter 2 outside the storage room 64. The boundary walls 68 separate the space in which the lifting transporter 2 is disposed from the storage room 64. The boundary walls 68 illustrated in FIG. 4 are arranged on opposite sides of the lifting transporter 2 in the lateral direction X and one side of the lifting transporter 2 in the aisle direction Y when viewed in the vertical direction Z to separate the space in which the lifting transporter 2 is disposed. More specifically, the boundary walls 68 illustrated in FIG. 4 include a first portion extending along the lifting transporter 2 in the lateral direction X at a position adjacent to the storage areas 12 in the aisle direction Y, and a second portion extending from opposite ends of the first portion in the lateral direction X along the opposite sides of the lifting transporter 2 in the lateral direction X. In the present embodiment, the boundary walls 68 separate the lifting transporter 2 from the storage room 64 to dispose the lifting transporter 2 in a space continuous with the external space of the automated warehouse 100. This structure lowers the expected performance of the lifting transporter 2 to substantially the same level as a lifting transporter 2 in the external space of the automated warehouse 100.

The boundary walls 68 illustrated in FIG. 4 overlap the first lateral conveyor 14A and the second lateral conveyor 14B when viewed in the vertical direction Z. The boundary walls 68 have doors 67 that open and close at positions of the first lateral conveyor 14A and the second lateral conveyor 14B, similarly to the partition wall 65 in the first embodiment. When the doors 67 are open, the articles W can be transferred between the first storage area 12A and the second storage area 12B through the first lateral conveyor 14A, the connecting transporter 14, and the second lateral conveyor 14B.

FIG. 5 shows another example of the boundary walls 68 shown in FIG. 4. The boundary walls 68 illustrated in FIG. 5 surround the space in which the lifting transporter 2 is disposed on opposite sides in the aisle direction Y and opposite sides in the lateral direction X. In this structure, the space in which the lifting transporter 2 is disposed is used to reduce the environmental differences between the first storage area 12A and the second storage area 12B. Although not shown in FIG. 5, a boundary wall 68 may also be disposed above the space in which the lifting transporter 2 is disposed as appropriate.

### Third Embodiment

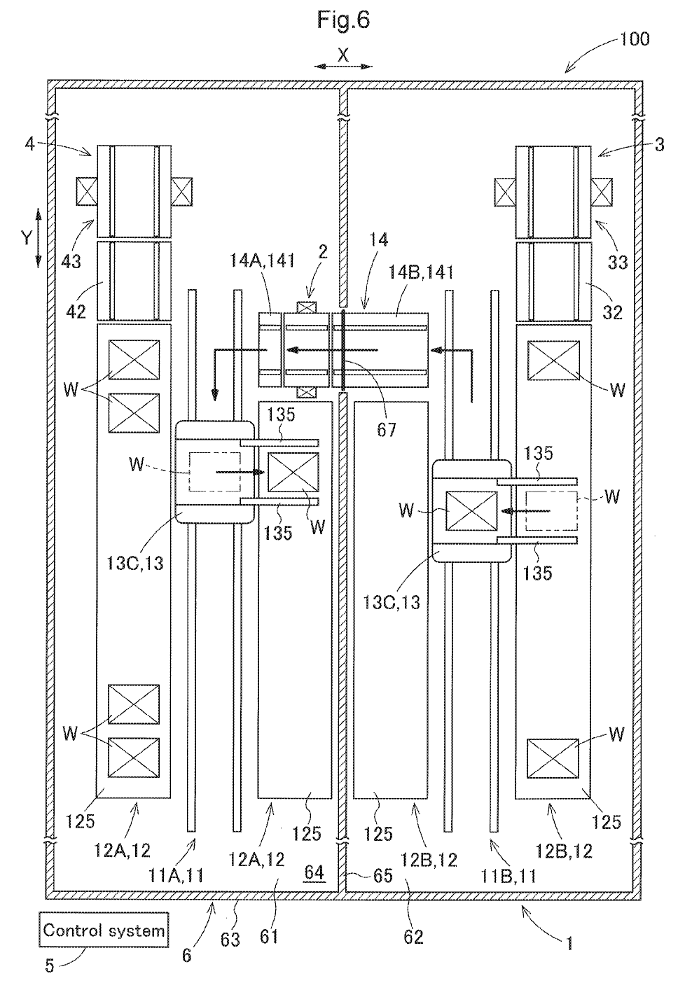

An automated warehouse 100 according to a third embodiment will now be described with reference to FIG. 6. The automated warehouse 100 according to the third embodiment differs from the automated warehouse 100 according to the first embodiment in the structures of the storage areas 12 and the transport vehicles 13. The automated warehouse 100 according to the third embodiment will be described focusing on its differences from the automated warehouse 100 according to the first embodiment. The common structures between the automated warehouse 100 according to the third embodiment and the automated warehouse 100 according to the first embodiment will not be described.

Unlike the storage areas 12 in the first embodiment, the storage areas 12 in the present embodiment include shelves 125 each in the form of a plate and supporting the entire bottom surface of each article W. The shelves 125 are arranged at positions corresponding to each floor F in the vertical direction Z. Each shelf 125 extends in the aisle direction Y, allowing multiple articles W to be arranged on the shelf 125 in the aisle direction Y.

The transport vehicles 13 in the present embodiment include a single type of carts 13C that travel along the transport aisles 11, unlike the transport vehicles 13 in the first embodiment. Each transport vehicle 13 according to the present embodiment differs from the transport vehicle 13 according to the first embodiment in that the mount surface 134 does not function as the transferrer and the transport vehicle 13 separately includes a transfer device 135.

The transfer device 135 moves the article W placed on the mount 133 to the storage area 12 or moves the article W stored in the storage area 12 to the mount 133. In the present embodiment, the transfer device 135 moves the articles W in one direction. This structure does not cause the articles W to be moved in multiple directions, thus simplifying the overall structure of each transport vehicle 13. More specifically, the transfer device 135 includes a pair of arms that extend and retract relative to the storage area 12 when the cart 13C is at a position adjacent to the storage area 12 in the lateral direction X. The pair of arms are arranged at an upper portion of the cart 13C with a space between the arms for placing an article W. To move the article W placed on the mount 133 to the storage area 12, the pair of arms extend toward the storage area 12 with the article W hooked on tabs (not shown) protruding from the pair of arms toward the space in which the article W is to be placed. The movement of the tabs protruding from the pair of arms moves the article W from the mount 133 to the storage area 12. To transfer the article W stored in the storage area 12 to the mount 133, the pair of arms that are extended toward the storage area 12 retract with the article W hooked on the tabs protruding from the pair of arms toward the space in which the article W is to be disposed. The movement of the pair of arms moves the article W from the storage area 12 to the mount 133.

### Other Embodiments

An automated warehouse 100 according to other embodiments will now be described.
1. In the above embodiment, the lifting transporter 2 also performs the loading and unloading operations. However, the lifting transporter 2 may simply transport the articles W between different floors F, without performing the loading and unloading operations.
2. In the above embodiment, each connecting transporter 14 is a conveyor. However, the connecting transporter 14 may be a transport vehicle 13. The transport vehicle 13 included in the connecting transporter 14 may move, for example, the transport vehicle 13 described in the third embodiment to another transport aisle 11.
3. In the above embodiment, the connecting transporter 14 connects the first transport aisle 11A and the second transport aisle 11B. In other words, the connecting transporter 14 connects the two transport aisles 11 adjacent to each other in the lateral direction X. However, the connecting transporter 14 may connect one transport aisle 11 of the two transport aisles 11 arranged on opposite sides of the connecting transporter 14 in the lateral direction X.
4. In the above embodiment, the transferrer included in the transport vehicle 13 transfers the article W to the connecting transporter 14. However, the transferrer that transfers the article W between the transport vehicle 13 and the connecting transporter 14 may be included in the connecting transporter 14.
5. In the above embodiment, the lifting transporter 2 includes the lift transferrer 23. However, the lifting transporter 2 may not include the lift transferrer 23 when the article W can be transferred between the lift mount 22 and the connecting transporter 14. In the above embodiment, the connecting transporter 14 includes the first lateral conveyor 14A and the second lateral conveyor 14B with the lifting transporter 2 disposed between the first lateral conveyor 14A and the second lateral conveyor 14B. Unlike the above embodiment, the connecting transporter 14 may move the article W between the transport aisles 11 that are adjacent to each other in the lateral direction X and are arranged on the same floor F without the lifting transporter 2. For example, the connecting transporter 14 may include a single lateral conveyor 141. In this case, the lateral conveyor 141 extends from a position adjacent to a first transport aisle 11 in the lateral direction X to a position adjacent to a second transport aisle 11 in the lateral direction X. The lifting transporter 2 is disposed at a position adjacent to the lateral conveyor 141 in the aisle direction Y. The lifting transporter 2 includes a device that transfers the article W between the lift mount 22 and the connecting transporter 14.
6. In the above embodiment, the loader 32 transfers the article W transferred to the automated warehouse 100 onto a warehouse layer 1, and the unloader 42 transfers the article W out of a warehouse layer 1. However, the loader 32 and the unloader 42 may be combined rather than being separate.
7. In the above embodiment, the loading lifter 33 transports the article W to the loader 32, and the unloading lifter 43 transports the article W to the shipping device 41. However, the loading lifter 33 and the unloading lifter 43 may not be separate components. The loading lifter 33 and the unloading lifter 43 may be combined rather than being separate, similarly to the lifting transporter 2.
8. In the above embodiment, the pair of lateral conveyors 141 are arranged on opposite sides of the lifting transporter 2 in the lateral direction X. However, the lifting transporter 2 may be disposed adjacent to a lateral conveyor 141 in the aisle direction Y. In this case, the lifting transporter 2 can transfer the articles W to and from the lateral conveyor 141 in the aisle direction Y.
9. In the above embodiment, the first temperature range includes room temperature, and the second temperature range includes the temperature appropriate for refrigeration. The first temperature range may be closer to room temperature than the second temperature range is. However, the first temperature range is not limited to include room temperature. For example, the first temperature range may include the temperature appropriate for refrigeration, and the second temperature range may include the temperature appropriate for freezing.
10. The structure described in each of the above embodiments may be combined with any other structures described in the other embodiments unless any contradiction arises. For other structures as well, the embodiments described herein are merely illustrative in all aspects. Thus, the embodiments described herein may be modified variously as appropriate without departing from the spirit and scope of the present disclosure.

### Overview of Present Embodiment

An overview of the automated warehouse according to the embodiments described above is provided below.

An automated warehouse includes warehouse layers on a plurality of floors arranged in a vertical direction, and a lifting transporter that transports articles in the vertical direction between the warehouse layers on respective floors of the plurality of floors. Each of the warehouse layers on the plurality of floors includes a plurality of transport aisles, a plurality of transport vehicles that each travel along a corresponding transport aisle of the plurality of transport aisles to transport articles, a storage area that stores articles, and a connecting transporter that connects the plurality of transport aisles to transport articles. The plurality of transport aisles are arranged in a lateral direction perpendicular to an aisle direction in which at least one of the plurality of transport aisles extends. The storage area is disposed along each of the plurality of transport aisles. The connecting transporter extends in the lateral direction. The connecting transporter transfers an article received from a transport vehicle on a first transport aisle of the plurality of transport aisles to a transport vehicle on a second transport aisle of the plurality of transport aisles. The lifting transporter connects, in the vertical direction, the connecting transporter on a first warehouse layer of the warehouse layers on the plurality of floors to the connecting transporter on a second warehouse layer of the warehouse layers. The lifting transporter transfers an article received from the connecting transporter on a floor of the plurality of floors to the connecting transporter on another floor of the plurality of floors.

In this structure, the connecting transporter is used to transport articles between different transport aisles on a warehouse layer on a single floor, and the connecting transporter and the lifting transporter are used to transport articles between multiple warehouse layers on different floors. This allows the articles to be easily moved between storage areas in the automated warehouse with a simple structure.

The connecting transporter may include a lateral conveyor that holds and transports a plurality of articles in the lateral direction.

In this structure, the lateral conveyor can hold multiple articles, thus allowing the connecting transporter to function as a buffer area for the articles waiting to be transported by the lifting transporter.

The automated warehouse may further include a loader configured to receive articles to be stored on a warehouse layer of the warehouse layers on the plurality of floors are transferrable, an unloader configured to convey articles outward from a warehouse layer of the warehouse layers on the plurality of floors are transferrable, a loading lifter that transports articles in the vertical direction between the warehouse layers on the plurality of floors and the loader, and an unloading lifter that transports articles in the vertical direction between the warehouse layers on the plurality of floors and the unloader. The lifting transporter may transport articles through a path different from paths for the loading lifter and the unloading lifter.

In this structure, different lifting transporters can be used to load an article onto a warehouse layer on one of the multiple floors, to unload an article from a warehouse layer on one of the multiple floors, and to move an article between storage areas in the automated warehouse. This allows each of these articles to be efficiently transported.

Each of the warehouse layers on the plurality of floors may further include a first temperature section in a first temperature range, a second temperature section in a second temperature range having temperatures different from temperatures in the first temperature range, a partition wall separating the first temperature section from the second temperature section, an opening in the partition wall to allow passage of articles, and a door that opens and closes the opening. The first temperature range may be closer to room temperature than the second temperature range is. The lifting transporter may be disposed in the first temperature section.

In this structure, the lifting transporter is disposed in an environment close to room temperature, lowering the level of expected performance of the lifting transporter. This simplifies the structure and reduces the cost of the lifting transporter.

Each of the warehouse layers on the plurality of floors may include a storage room surrounded by a surrounding wall. The storage area may be disposed inside the storage room. The storage room may be maintained to satisfy a preset environmental condition. The lifting transporter may be disposed outside the storage room.

In this structure, the lifting transporter does not affect the internal environment of the storage room, reducing the cost to maintain the internal environment of the storage room and the cost of the lifting transporter with a low level of expected performance.

### INDUSTRIAL APPLICABILITY

The technique according to one or more embodiments of the present disclosure is usable for an automated warehouse including warehouse layers arranged on multiple floors and a lifting transporter that transports articles between the warehouse layers on different floors.

What is claimed is:

1. An automated warehouse, comprising:
warehouse layers on a plurality of floors arranged in a vertical direction; and
a lifting transporter configured to transport articles in the vertical direction between the warehouse layers on respective floors of the plurality of floors, and
wherein:
each of the warehouse layers on the plurality of floors comprises:
a plurality of transport aisles,
a plurality of transport vehicles each configured to travel along a corresponding transport aisle of the plurality of transport aisles to transport articles,
a storage area configured to store articles, and
a connecting transporter configured to connect the plurality of transport aisles to transport articles,
the plurality of transport aisles is arranged in a lateral direction perpendicular to an aisle direction in which at least one of the plurality of transport aisles extends,
the storage area is disposed along each of the plurality of transport aisles,
the connecting transporter extends in the lateral direction and is configured to transfer an article received from a transport vehicle on a first transport aisle of the plurality of transport aisles to a transport vehicle on a second transport aisle of the plurality of transport aisles,
the lifting transporter is configured to connect, in the vertical direction, the connecting transporter on a first warehouse layer of the warehouse layers on the plurality of floors to the connecting transporter on a second warehouse layer of the warehouse layers, the lifting transporter configured to transfer an article received from the connecting transporter on a floor of the plurality of floors to the connecting transporter on another floor of the plurality of floors.

2. The automated warehouse according to claim 1, wherein:
the connecting transporter comprises a lateral conveyor configured to hold and transport a plurality of articles in the lateral direction.

3. The automated warehouse according to claim 1, further comprising:
a loader to configured to receive articles to be stored on a warehouse layer of the warehouse layers on the plurality of floors are transferrable;
an unloader configured to convey articles outward from a warehouse layer of the warehouse layers on the plurality of floors;
a loading lifter configured to transport articles in the vertical direction between the warehouse layers on the plurality of floors and the loader; and
an unloading lifter configured to transport articles in the vertical direction between the warehouse layers on the plurality of floors and the unloader, and
wherein the lifting transporter is configured to transport articles through a path different from paths for the loading lifter and the unloading lifter.

4. The automated warehouse according to claim 1, wherein:
each of the warehouse layers on the plurality of floors further comprises:
a first temperature section in a first temperature range,
a second temperature section in a second temperature range having temperatures different from temperatures in the first temperature range,
a partition wall separating the first temperature section from the second temperature section,
an opening in the partition wall to allow passage of articles, and
a door configured to open and close the opening,
the first temperature range is closer to room temperature than the second temperature range is, and
the lifting transporter is disposed in the first temperature section.

5. The automated warehouse according to claim 1, wherein:
each of the warehouse layers on the plurality of floors comprises a storage room surrounded by a surrounding wall,
the storage area is disposed inside the storage room,
the storage room is maintained to satisfy a preset environmental condition, and
the lifting transporter is disposed outside the storage room.
